(19) United States
(12) Patent Application Publication
(10) Pub. No.: US 2020/0394616 A1
(43) Pub. Date: Dec. 17, 2020

(54) BENEFIT TRACKING AND AVAILABILITY IN AN ENROLLMENT DATABASE SYSTEM

(71) Applicant: ZenPayroll, Inc., San Francisco, CA (US)

(72) Inventor: Alexander Evanczuk, San Francisco, CA (US)

(21) Appl. No.: 16/440,995

(22) Filed: Jun. 14, 2019

(51) Int. Cl. G06Q 10/10; G06Q 40/08

(52) U.S. Cl. CPC G06Q 10/1057; G06Q 40/08

(57) ABSTRACT

A central enrollment database system displays a benefits interface on a client device of an individual belonging to an organization. The benefits interface including a plurality of benefits corresponding to an organization to which the individual belongs. The central enrollment database system identifies a first set of the plurality of benefits, wherein a set of eligibility rules corresponding to each of the first set of benefits is satisfied by an accessed set of personnel data, and a second set of the plurality of benefits, wherein a set of eligibility rules corresponding to each of the second set of benefits is not satisfied by the accessed set of personnel data. The central enrollment database system modifies the benefits interface to indicate that individual is eligible for the first set of benefits, that the individual is not eligible second set of benefits, and the corresponding eligibility rules.

This disclosure relates generally to enrollment database systems, and more specifically to identifying and displaying eligibility of individuals for benefits in a central enrollment database system.

### BACKGROUND

Organizations, such as companies employing a number of individuals, often offer benefits to members of their organizations. Available benefits may only be offered to eligible individuals who satisfy specific requirements. In many cases, determining that an individual or employee is eligible for a benefit that is offered by an organization involves a complex set of eligibility rules and parameters of a benefits system. The parameters may be dependent on various information about the individual and/or the organization. In some cases, the eligibility of an individual is based on information voluntarily provided by the individual, and the eligibility may change over time due to changes in an individual's personal or employment history. For the individual, the process of determining eligibility, including the eligibility rules, may not be transparent. Additionally, in a conventional system for enrolling in benefits, the individual may not be aware of how one's eligibility for benefits changes according to the parameters of the benefit system. There is a need for dynamically determining and tracking an individual's eligibility for a set of benefits in a benefits system. Likewise, there is a need for an interface for effectively communicating how an individual's benefits dynamically change.

### SUMMARY

An individual's eligibility for benefits offered by an organization can be tracked and managed by a central enrollment database system. Using a benefits interface provided by the central enrollment database system, the individual can view and manage their benefits with the ability to easily and efficiently understand the factors contributing to their eligibility for various benefits. In some cases, the central enrollment database system also allows the user to perform actions to change their eligibility for benefits that they may not originally be eligible for.

The central enrollment database system includes a benefits engine and an interface engine. The interface engine displays a benefits interface on a client device of an individual. The benefits interface includes a plurality of benefits corresponding to the organization to which the individual belongs.

For each of the plurality of benefits, the benefits engine accesses a set of eligibility rules corresponding to the benefit, wherein each eligibility rule in the set of eligibility rules must be satisfied by the individual in order for the individual to be eligible for the benefit. The benefits engine accesses a set of personnel data for the individual from a database corresponding to the organization. The benefits engine identifies a first set of the plurality of benefits, wherein the set of eligibility rules corresponding to each of the first set of benefits is satisfied by the accessed set of personnel data. The interface engine modifies the benefits interface displayed by the client device by indicating that the individual is eligible for the first set of benefits

The benefits engine identifies a second set of the plurality of benefits, wherein the set of eligibility rules corresponding to each of the second set of benefits is not satisfied by the accessed set of personnel data. The benefits engine identifies, for each benefit of the second set of benefits, one or more of the set of eligibility rules corresponding to the benefit that are not satisfied. The interface engine modifies the benefits interface displayed by the client device by indicating that the individual is not eligible for the second set of benefits. The benefits interface is also modified to indicate, for each benefit of the second set of benefits, the identified one or more of the set of eligibility rules corresponding to the benefit that are not satisfied. The benefits interface is also modified to include a narrative description indicating why each of the eligibility rules are not satisfied (e.g., which characteristics associated with the user is preventing the user from satisfying the eligibility rule, missing characteristics of the user that are required to satisfy the eligibility rule, and other factors required to satisfy the eligibility rule, such as the passage of an amount of time or an upcoming eligibility date). Finally, the benefits interface can be modified to include, for one or more of the second set of benefits, an interface element configured to, when the individual interacts with the interface element, enable the individual to perform one or more actions in order to satisfy the identified one or more of the set of eligibility rules corresponding to the benefit that are not satisfied (for instance, by providing additional information, by electing or rejecting one or more other benefits, by changing a status or characteristic of the user, and the like).

### BRIEF DESCRIPTION OF THE DRAWINGS

FIG. 1 is a block diagram of a system environment in which a central enrollment database system operates, in accordance with an embodiment.

FIG. 2 is an interaction diagram for a benefits engine of a central enrollment database system, in accordance with an embodiment.

FIG. 3 is an example user interface (UI) for managing enrollment in benefits of a central enrollment database system, in accordance with an embodiment.

FIGS. 4A-4C are examples of eligibility UIs for indicating eligibility of an individual for benefits of a central enrollment database system, in accordance with an embodiment.

FIG. 5 is a flowchart illustrating a process for determining subsets of benefits in a central enrollment database system and modifying a benefits interface to indicate the subsets of benefits to an individual, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

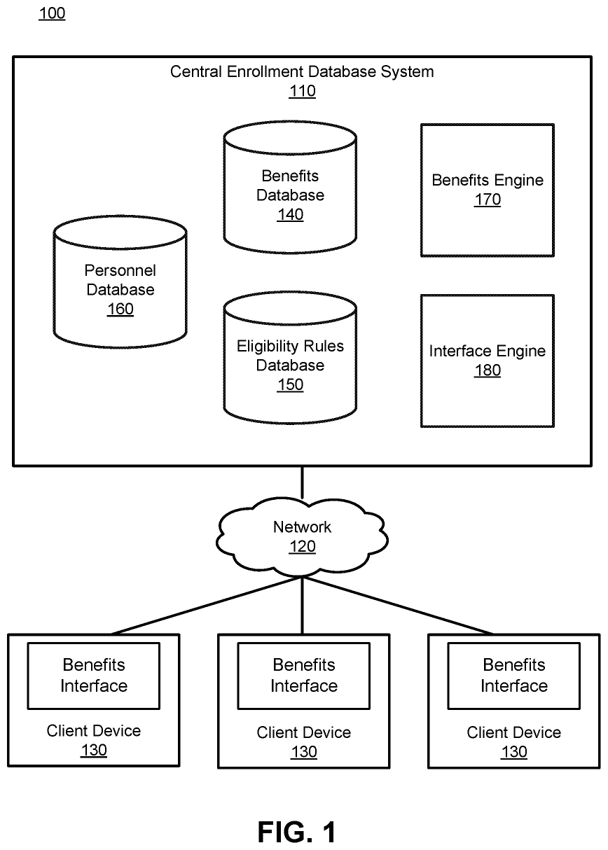

FIG. 1 is a block diagram of a system environment in which a database system operates, in accordance with an embodiment. The system environment 100 shown by FIG. 1 includes a central enrollment database system 110, a network 120, and one or more client devices 130. The system environment 100 may have alternative configurations than shown in FIG. 1, including for example different, fewer, or additional components.

The central enrollment database system 110 stores and maintains a benefits database 140, an eligibility rules database 150, a personnel database 160, and related modules to organize and store data within the databases, and to manage access to the stored data. In one embodiment, the central enrollment database system 110 operates on a central computer or database system, such as a server or set of servers operating within a datacenter. The central enrollment database system 110 is configured to communicate with a network 120 and may be accessed by client devices 130 via the network 120. Each of the client devices 130 may include a computer system that may include a display and input controls that enable a user of the database system 110 to interact with a user interface for accessing, viewing, and/or manipulating data. The central enrollment database system 110 shown in FIG. 1 includes a benefits database 140, an eligibility rules database 150, a personnel database 160, a benefits engine 170, and an interface engine 180. In other embodiments, the central enrollment database system 110 may contain additional, fewer, or different components for various applications. Conventional components such as network interfaces, security functions, load balancers, failover servers, management and network operations consoles, and the like are not shown so as to not obscure the details of the system architecture.

The benefits database 140, the eligibility rules database 150, and the personnel database 160 store and maintain data for the central enrollment database system 110. The stored data in the benefits database 140 includes information on benefits policies offered to individuals that are part of an organization associated with the central enrollment database system 110. For example, the central enrollment database system 110 may be associated with a company including a number of employees, and stored data may include information regarding benefits policies offered to the employees of the company.

The stored data in the eligibility rules database 150 includes one or more eligibility rules associated with each benefit policy, also referred to herein as a “benefit,” stored in the benefits database 140. Each of the eligibility rules includes a set of conditions that must be satisfied for an individual to be eligible for the associated benefit policy. For example, an eligibility rule for a benefit may be that an employee must be employed with the corresponding company for a minimum of two years. In some embodiments, a plurality of eligibility rules may correspond to a single benefit policy. In some embodiments, benefits policies stored in the benefits database 140 and eligibility rules stored in the eligibility rules database 150 can only be added or modified by authorized users of the central enrollment database system 110. The authorized users may be administrators managing the central enrollment database system.

According to some embodiments, an eligibility rule may include a rule based on at least one of: an employment status of the individual, an age of the individual, a salary of the individual, a role or title of the individual, a health status of the individual, a behavioral status of the individual, a tenure of the individual at the organization, a residence of the individual, a life event of the individual, a parental status of the individual, a number of dependents of the individual, an enrollment status of dependents of the individual, and an enrollment of the individual in a benefit. For example, an eligibility rule may require an individual to have been an employee of the organization for a minimum of three years.

In other embodiments, an eligibility rule applies to the organization associated with the central enrollment database system. Such eligibility rules may include a rule based on at least one of: an allowance for a number of enrolled individuals for the organization, a location of the organization, a legal requirement of the organization, and a policy set by the organization. For example, a company may be required by law to offer a transportation reimbursement benefit for employees.

The stored data in the personnel database 160 includes personnel data on individuals belonging to the organization associated with the central enrollment database system 110. The personnel data may include information on each of the individuals, such as biographic and demographic information, according to some embodiments. The information may include historical information on the individual, as well as information regarding the relationship between the individual and the organization. For example, the personnel database 160 may include a hiring date of an employee at a company. In some embodiments, the information for an individual includes sensitive information that is restricted, such that only authorized users of the central enrollment database system or users with particular access permissions may access and/or modify the sensitive information, in the personnel database 160. Various types of data may be stored in the personnel database 160. For example, data may include financial transaction data, personally identifiable information (“PII”), healthcare records, user data (for instance, describing a user's actions or communications within a network), social media data, sensor data, and the like. Some or all of the data stored in the personnel database 160 may be sensitive information, such as social security numbers, phone numbers, full names of individuals, and/or addresses of individuals.

In some embodiments, the personnel data includes data corresponding to one or more dependents of the individual. Additionally, the plurality of benefits available for individual may include benefits corresponding to the one or more dependents. For example, the personnel data may include information such as an age of a child in the individual's family. In this case, a benefit may include a health insurance plan for the child, with a corresponding eligibility rule requiring the child be under a threshold age.

The benefits engine 170 accesses data from the benefits database, the eligibility rules data base, and personnel database 160 to identify a first set of benefits that an individual in the associated organization is eligible for, based on the accessed data. The benefits engine 170 also identifies the corresponding set of eligibility rules for each of the identified benefits. In some embodiments, the benefits engine 170 stores the identified first set of benefits and the corresponding eligibility rule in a database, e.g. the personnel database 160.

The benefits engine 170 also identifies a second set of benefits that the individual is not currently eligible for. Within the second set of benefits, the benefits engine 170 identifies benefits that the individual will become eligible for, if the individual performs a corresponding action through the central enrollment database system 110, according to some embodiments. For example, the benefits engine 170 identifies that an employee of a company may currently be ineligible for participation in a retirement fund because they have not provided updated information on their number of dependents to the central enrollment database system 110. The benefits engine 170 then identifies that the employee may then become eligible for participation in the retirement fund by taking action, using the central enrollment database system 110, to update the personnel database 160 with up-to-date information regarding their number of dependents. In some embodiments, the benefits engine stores the identified second set of benefits and the corresponding eligibility rules in a database, e.g. the personnel database 160.

The interface engine 180 displays on a client device 130 a benefits interface to an individual, herein referred to as a user, belonging to the organization associated with the central enrollment database system 110. The benefits interface displays benefits offered by the organization and allows the user to enroll in benefits by interacting with the benefits interface. The interface engine 180 modifies the benefits interface based on sets of benefits identified by the benefits engine 170, to indicate benefits that the user is eligible for, that the user is ineligible for, and that the user may become eligible for by performing actions through the central enrollment database system 110. The interface engine 180 also modifies the benefits interface to provide information regarding why the user is or is not eligible for each benefit, including sets of eligibility rules corresponding to the benefit.

The client devices 130 are one or more computing devices capable of receiving user input as well as transmitting and/or receiving data via the network 120. In one embodiment, a client device 130 is a conventional computer system, such as a desktop or a laptop computer. Alternatively, a client device 130 may be a device having computer functionality, such as a personal digital assistant (PDA), a mobile telephone, a smartphone, or another suitable device. A client device 130 is configured to communicate with the central enrollment database system 110 via the network 120, for example using a native application executed by the client device 130 or through an application programming interface (API) running on a native operating system of the client device 130, such as IOS® or ANDROID™. In another example, the client device 130 is configured to communicate with the central enrollment database system 110 via an API running on the central enrollment database system 110.

The central enrollment database system 110 and the client devices 130 are configured to communicate via the network 120, which may comprise any combination of local area and/or wide area networks, using wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

Each client device 130 is configured to request and access data in the benefits database 140, the eligibility rules database 150, and the personnel database 160 via the network 120, according to some embodiments. The requested data is displayed in the benefits interface on the client device 130 for an authorized user. In some embodiments, the client device 130 is a computing device associated with a user who is a member of the organization associated with the central enrollment database system 110. In some embodiments, the benefits interface displayed on the client device 130 is modified by the interface engine 170, based on inputs provided by the user via the client device 130. The inputs may include interactions to perform an action to satisfy one or more eligibility rules corresponding to a benefit.

### Benefits Engine

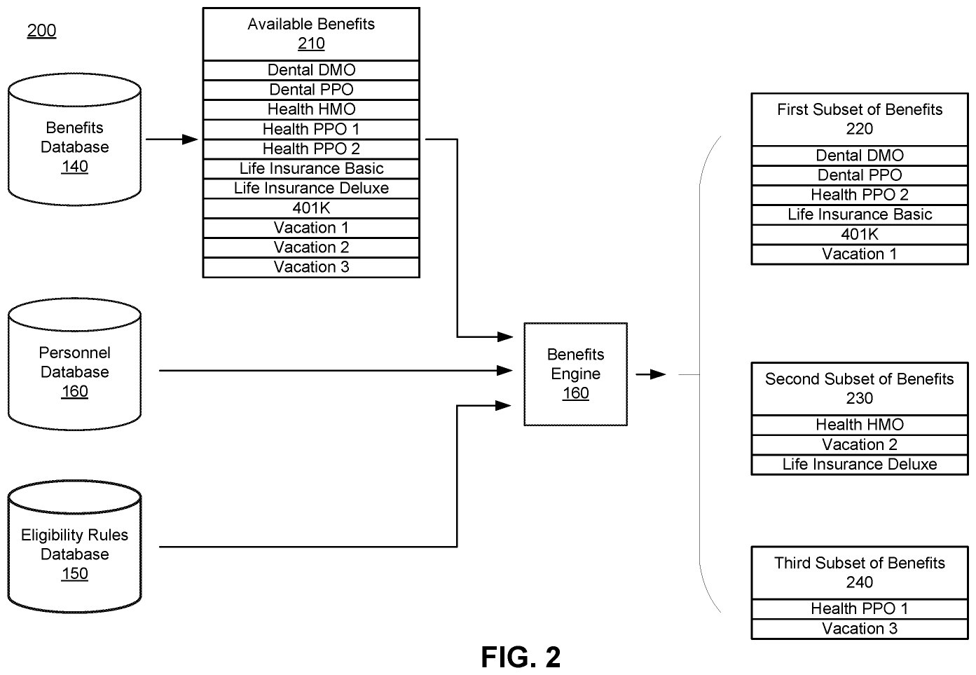

FIG. 2 is an interaction diagram for a benefits engine of a central enrollment database system, in accordance with an embodiment. The benefits engine 160 accesses from the benefits database 140 a set of available benefits 210 for individuals belonging to the organization associated with the central enrollment database system 110. The benefits engine 160 also accesses personnel data with an individual from the personnel database 160. In some embodiments, the personnel data from the personnel database includes biographical information.

For each benefit in the set of available benefits 210, the benefits engine 160 accesses a set of eligibility rules corresponding to the benefit. Each eligibility rule from the set must be satisfied by the individual in order for the individual to be eligible for the benefit. Based on the accessed personnel data and the eligibility rules corresponding to each available benefit, the benefits engine 160 identifies different subsets of the available benefits 210.

The benefits engine 160 identifies a first subset of benefits 220, also referred to as “a first set of benefits,” herein. The first subset of benefits 220 includes benefits that the individual is eligible for, based on the individual satisfying each of the eligibility rules associated with the benefits. The benefits engine 160 determines that each of the eligibility rules corresponding to a benefit of the first subset of benefits 220 is satisfied by the accessed personnel data for the individual. For example, as shown in FIG. 2, an individual is eligible for a dental DMO insurance plan, based on the accessed eligibility rules corresponding to the dental DMO insurance plan and the accessed personnel data for the individual. The benefits engine 160 identifies the dental DMO insurance plan as included in the first subset of benefits 220. In the example shown in FIG. 2, a dental PPO insurance plan, a health PPO 2 insurance plan, a basic life insurance plan, a 401K benefit, and a vacation policy 1 benefit are also included in the first subset of benefits 220.

In some embodiments, the central enrollment database system 110 receives a set of preferences associated with the individual. For example, the individual may indicate a preference for a specific type of health insurance plan. The benefits engine 160 may enroll the individual in a subset of the first set of benefits based on the received set of preferences.

The benefits engine 160 also identifies a second subset of benefits 230. The second subset of benefits 230 includes benefits that the individual is not currently eligible for, based on the individual not satisfying one or more of the eligibility rules corresponding to each benefit. The benefits engine 160 determines that one or more of the eligibility rules corresponding to a benefit of the second subset of benefits 230 is not currently satisfied by the accessed personnel data for the individual. For each benefit of the second subset of benefits 230, the benefits engine 160 also identifies one or more of the eligibility rules from the set of eligibility rules corresponding to the benefit that are not satisfied. For example, as shown in FIG. 2, an individual is not eligible for a health HMO insurance plan, based on the accessed eligibility rules corresponding to the health HMO insurance plan and the accessed personnel data for the individual. The benefits engine 160 identifies the health HMO insurance plan as included in the second subset of benefits 230 and identifies one or more eligibility rules from the set of eligibility rules corresponding to the health HMO insurance plan. The identified one or more eligibility rules are not satisfied by the accessed set of personnel data. In the example shown in FIG. 2., a vacation policy 2 benefit and a deluxe life insurance plan are also included in the second subset of benefits 230.

For each benefit of the second subset of benefits 230, the benefits engine 160 determines that the individual will become eligible for the benefit if the one or more identified eligibility rules are satisfied by the individual performing one or more actions. For example, the individual may become eligible for the health HMO insurance plan by reporting a qualifying life event, e.g. the birth of a child in the individual's family. The benefits engine 160 identifies the one or more actions based on the identified one or more eligibility rules that are not currently satisfied by the accessed personnel data for the individual, and when the identified one or more actions are performed by the user, via the central enrollment database system 110, the identified one or more eligibility rules may then be satisfied.

The identified one or more actions may result in updating the stored data in the personnel database 160, according to some embodiments. For example, the identified one or more actions may include updating and/or changing data in the personnel database 160 to reflect a change in employment information, such as a change in role or title, a change in number of expected hours worked (e.g. for a part-time employee), a change in the user's sub-organization within the organization. The identified one or more actions may include updating and/or changing data in the personnel database 160 to reflect a change in residence for the user, a change in location of employment, reporting of a life event (e.g. a death in a family), changing a number of reported dependents for the individual, and other changes for the user. The identified one or more actions may also include changing a user's benefits elections (e.g. changing which health insurance plan the user is enrolled in), changing a user's earnings (i.e. paycheck, salary, or wage) withholdings (e.g. for tax purposes or for a retirement/savings benefit), and other actions.

The user may then perform the action via the benefits engine 160, for example through the benefits interface on a client device 130. Once the one or more actions have been performed, the benefits engine 160 updates the personnel database 160 to reflect any changes in the personnel data caused by the one or more actions. Based on the updated personnel data after the individual has performed the one or more actions, the benefits engine 160 moves the benefit from the second subset of benefits 230 into the first subset of benefits 220.

The benefits engine 160 identifies a third subset of benefits 240. The third subset of benefits 240 includes benefits that the individual is not currently eligible for, based on the individual not satisfying one or more of the eligibility rules corresponding to each benefit. For each benefit of the third subset of benefits 240, the benefits engine 160 also identifies one or more eligibility rules from the set of eligibility rules corresponding to the benefit that are not satisfied. The benefits engine 160 determines that the individual cannot currently take any actions to satisfy all of the one or more identified eligibility rules to become eligible for the benefits of the third subset of benefits 240, according to some embodiments. For example, as shown in FIG. 2, the individual is not eligible for a health PPO 1 insurance plan, based on the accessed eligibility rules corresponding to the health PPO 1 insurance plan and the accessed personnel data for the individual. The benefits engine 160 identifies the health insurance plan as included in the third subset of benefits 230 and identifies one or more eligibility rules from the set of eligibility rules corresponding to the health PPO 1 insurance plan that are not satisfied by the accessed personnel data. The benefits engine 160 determines that the individual cannot currently take any actions to satisfy all of the one or more identified eligibility rules. In the example shown in FIG. 2, a vacation policy 3 benefit is also included in the third subset of benefits 240.

The second subset of benefits 230 and the third subset of benefits 240 may be referred to as a “second set of benefits,” herein.

### Benefits Interface

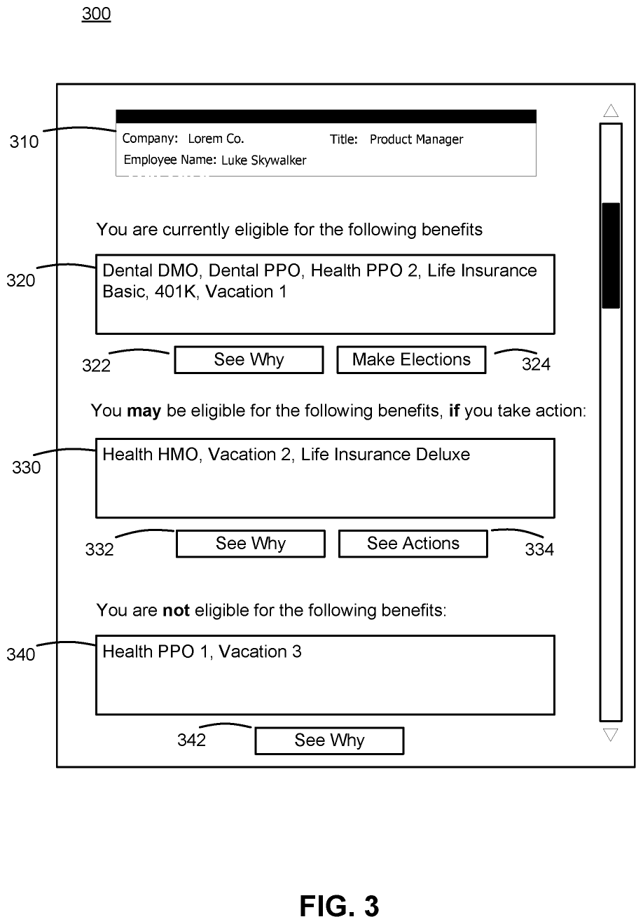

FIG. 3 is an example user interface (UI) for managing enrollment in benefits of a central enrollment database system, in accordance with an embodiment. The interface engine 180 provides the example UI 300 for display on a client device 130. The example UI 300 is an embodiment of the benefits interface, as shown in FIG. 1. The example UI 300 includes a first field 310 associated with an individual, also referred to as a “user” herein, a second field 320 associated with the first subset of benefits 220, a third field 330 associated with the second subset of benefits 230, and a fourth field 340 associated with the third subset of benefits 240. In other embodiments, the example UI 300 includes a different number or configuration of fields. For example, the example UI 300 may include an individual field for each of the benefits in the set of available benefits 210.

The first field 310 displays information based on the personnel data accessed by the benefits engine 160. The information displayed in the first field 310 includes relevant information regarding the individual. For example, the first field 310 display information including a name of the organization associated with the central enrollment database system 110, a name of the individual, and a relationship between the organization and the individual (e.g. a role or title of the individual within the organization). In some embodiments, the first field 310 displays different information regarding the individual and/or the organization than what is shown in FIG. 3.

The second field 320 displays information based on the first subset of benefits 220. The second field 320 indicates at least one of the benefits from the first subset of benefits 220. The information displayed in the second field 320 includes relevant information regarding the indicated benefits, and the example UI 300 indicates that the individual is eligible for each of the benefits included in the second field 320. In some embodiments, the second field 320 includes all the benefits in the first subset of benefits 220. In other embodiments, the information displayed in the second field 320 may also include additional details on each indicated benefit. The information displayed in the second field 320 may also include explanations for why the individual is eligible for each indicated benefit.

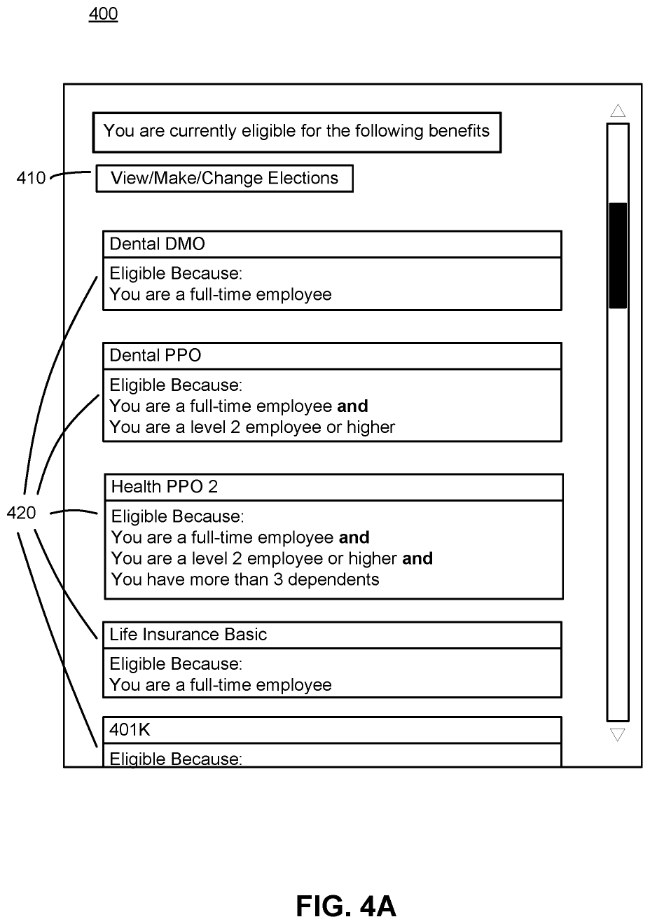

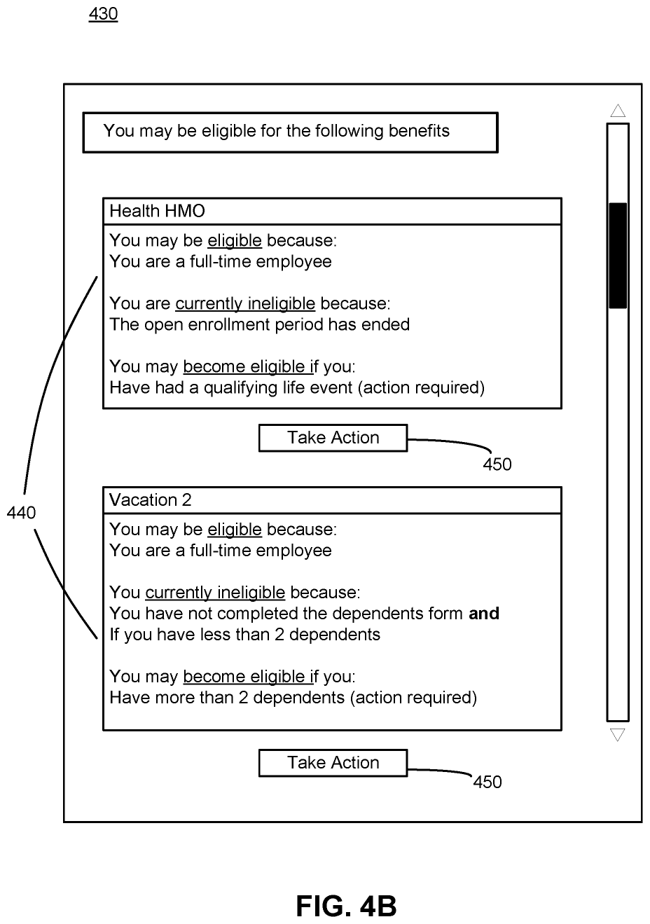

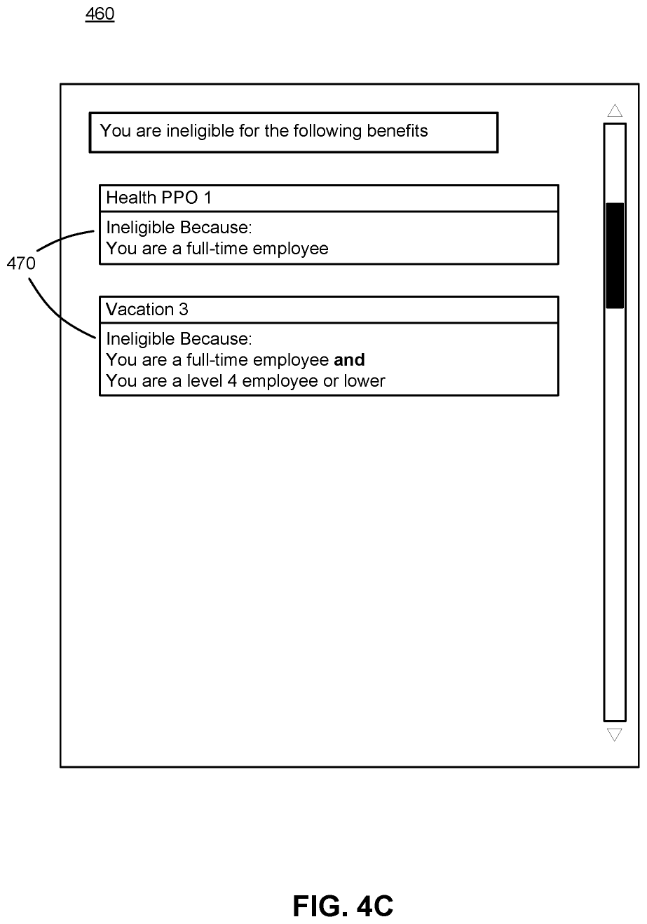

The example UI 300 also includes a first interactive element 322 and a second interactive element 324. An interactive element in the example UIs shown in FIGS. 3 and 4A-4C may also be referred to herein as an “interface element.” When a user interacts with the first interactive element 322, the interface engine 180 modifies the benefits interface to display an explanation for each benefit indicated in the second field 320, including information related to why the individual is eligible for the benefit. The explanation is based on the eligibility rules corresponding to the benefit which are satisfied by the personnel data accessed by the benefits engine 170. An example of the modified example UI 300, after a user has interacted with the first interactive element 322 is shown in FIG. 4A.

The second interactive element 324 allows the user to enroll in at least one of the benefits indicated in the second field 320. After the user interacts with the second interactive element 324, the interface engine 180 modifies the example UI 300 to display an elections interface for enrolling the individual in at least one of the benefits indicated in the first field 320, according to some embodiments. The user may interact with the elections interface to enroll in the at least one of the benefits through the central enrollment database system110.

The third field 330 displays information based on the second subset of benefits 230. The third field 330 indicates at least one of the benefits from the second subset of benefits 230. The information displayed in the third field 330 includes relevant information regarding the indicated benefits, and the example UI 300 indicates that the individual is ineligible for each of the indicated benefits. The example UI 300 also indicates that the individual will become eligible for the indicated benefits, if the individual performs one or more actions corresponding to each of the indicated benefits, according to some embodiments. In some embodiments, the third field 330 indicates all of the benefits in the second subset of benefits 230. In other embodiments, the information displayed in the third field 330 also includes additional details on each indicated benefit. The information displayed in the third field 330 may also include explanations for why the individual is ineligible for each indicated benefit, according to some embodiments.

The example UI 300 also includes a third interactive element 332 and a fourth interactive element 334. When a user interacts with the third interactive element 332, the interface engine 180 modifies the benefits interface to display an explanation for each benefit indicated in the third field 330, including information related to why the individual is ineligible for the benefit. The explanation is based on the eligibility rules corresponding to each indicated benefit, some of which are not satisfied by the personnel data accessed by the benefits engine 170. An example of the modified example UI, after a user has interacted with the third interactive element 332 is shown in FIG. 4B.

The fourth interactive element 334 allows the user to perform actions to satisfy eligibility rules corresponding to the benefits indicated in the third field 330. After the user interacts with the fourth interactive element 334, the interface engine 180 modifies the example UI 300 to display an interface for performing actions through the central enrollment database system 110. By interacting with the interface, the user may perform the actions that satisfy the one or more previously unsatisfied eligibility rules corresponding to one or more of the benefits indicated in the third field 330. In response to the user interacting with the fourth interactive element and performing actions through the central enrollment database system 110, the benefits engine 170 may update the personnel database. The benefits engine 170 may then determine that the user now satisfies each of the eligibility rules from the set of eligibility rules corresponding to one of the benefits indicated in the third field 330 and move the benefit out of the second subset of benefits 230 into the first subset of benefits 220. The interface engine 180 modifies the example UI 300 to move the at least one of the benefits from the from the third field 330 to a field associated with the first subset of benefits 220, e.g. the second field 320.

The fourth field 340 displays information based on the third subset of benefits 240. The fourth field 340 indicates at least one benefit from the third subset of benefits 240. The information displayed in the fourth field 340 includes relevant information regarding the indicated benefit, and the example UI 300 indicates that the individual is ineligible for each of the benefits listed in the fourth field 340. In some embodiments, the fourth field 340 indicates all of the benefits in the third subset of benefits 240. In other embodiments, the information displayed in the fourth field 340 may also include additional details on each indicated benefit. The information displayed in the fourth field 340 may also include explanations for why the individual is ineligible for each indicated benefit.

The example UI 300 also includes a fifth interactive element 342. When a user interacts with the fifth interactive element 342, the interface engine 180 modifies the benefits interface to display an explanation for each benefit indicated in the fourth field 340 including information related to why the individual is ineligible for the benefit. The explanation is based on the eligibility rules corresponding to the benefit which are not satisfied by the personnel data accessed by the benefits engine 170. An example of the modified example UI, after a user has interacted with the fifth interactive element 342 is shown in FIG. 4C.

FIGS. 4A-4C are examples of eligibility UIs for explaining the eligibility of an individual for benefits of a central enrollment database system, in accordance with an embodiment. An eligibility UI may have other configurations, with various other elements than are shown in FIGS. 4A-4C, according to some embodiments. In some embodiments, the interface engine 180 modifies the benefits interface to display one of the example UIs of FIGS. 4A-4C, after a user interacts with a corresponding one of the first interactive element 322, the third interactive element 332, and the fifth interactive element 342.

According to some embodiments, the interface engine 180 modifies the benefits interface to display an example UI, also referred to as a first eligibility UI 400, shown in FIG. 4A, in response to the user interacting with the first interactive element 322. In this case, the first eligibility UI 400 display information related to associated benefits. The benefits associated with the first eligibility UI 400 include the benefits indicated in the second field 320. The first eligibility UI 400 includes an interactive element 410 for viewing, making, and changing one or more elections, also referred to as “enrollments” herein, in the benefits associated with the first eligibility UI 400. In some embodiments, the benefits engine modifies the benefits interface to display a separate elections interface for viewing, making, and changing one or more elections. The elections interface may be the same elections interface displayed in response to the user interacting with the second interactive element 324, as shown in FIG. 3.

The first eligibility UI 400 also includes one or more benefit fields 420. Each benefit field 420 indicates one of the benefits associated with the first eligibility UI 400 and displays information relevant to the indicated benefit. The displayed information in each benefit field 420 includes an explanation of each of the eligibility rules corresponding to the indicated benefit that are satisfied by the accessed personnel data. For each of the satisfied eligibility rules, the explanation in the benefit field 420 may also indicate the accessed personnel data that satisfies the eligibility rule. In other embodiments, additional information may be displayed in the benefit field 420.

For example, as shown in FIG. 4A, a benefit field 420 indicates that the user is eligible for a dental DMO insurance benefit, as identified by the benefits engine 170. The dental DMO insurance benefit has one corresponding eligibility rule, requiring the user to be a full-time employee of Lorem Co., the example organization associated with the central enrollment database system 110. The respective benefit field 420 indicates that the user is eligible for the dental DMO insurance benefit because the benefits engine 170 has identified that the user is indeed a full-time employee of Lorem Co., based on the accessed personnel data.

According to some embodiments, the interface engine 180 modifies the benefits interface to display an example UI, also referred to as a second eligibility UI 430, shown in FIG. 4B, in response to the user interacting with the third interactive element 332. In this case, the second eligibility UI 430 display information related to associated benefits associated. The benefits associated with the second eligibility UI 430 include the benefits indicated in the third field 330.

The second eligibility UI 430 also includes one or more benefit fields 440. Each benefit field 440 indicates one of the benefits associated with the second eligibility UI 430 and displays information relevant to the indicated benefit. The displayed information in each benefit field 440 includes an explanation for which eligibility rules corresponding to the indicated benefit are satisfied by the accessed personnel data, an explanation for which eligibility rules corresponding to the indicate benefit are not satisfied by the accessed personnel data, and an explanation for how a user may become eligible for the indicated benefit by performing one or more actions, based on the eligibility rules corresponding to the indicated benefit and the personnel data for the user accessed by the benefits engine 170. For each of the eligibility rules, the explanation in the benefit field 440 may also indicate the accessed personnel data that satisfies or does not satisfy the eligibility rule. In other embodiments, additional information may be displayed in the benefit field 440.

The explanation for how a user may become eligible for the indicated benefit by performing an action may include information regarding one or more eligibility rules that the user may satisfy by performing an action through the central enrollment database system 110, as determined by the benefits engine 170. The explanation may include more than one action corresponding to the benefit. In some embodiments, the explanation also includes a recommendation corresponding to the action. The user may perform the action, through the benefits engine 170, by interacting with a respective interactive element 450. In some embodiments, the interface engine 180 modifies the benefits interface to display a separate actions interface for performing actions to satisfy the one or more eligibility rules, in response to the user interacting with the interactive element 450. The actions interface may be the same actions interface displayed in response to the user interacting with the fourth interactive element 344, as shown in FIG. 3. In some embodiments, the interface engine 180 modifies the second eligibility UI 430 to remove a benefit field 440, after a user has performed one or more actions to satisfy all of the eligibility rules corresponding to the indicated benefit indicated in the benefit field 440.

For example, as shown in FIG. 4B, a benefit field 440 indicates that the user is ineligible for a health HMO insurance plan, as identified by the benefits engine 170. The health HMO insurance plan has two corresponding eligibility rules. The first eligibility requires the user to be a full-time employee of Lorem Co., the example organization associated with the central enrollment database system 110. The second eligibility rule requires the user to enroll during an open enrollment period or requires the user to report a qualifying life event. An explanation in the benefit field 440 indicates that the user satisfies the first eligibility rule for the health HMO insurance plan because the benefits engine 170 has identified that the user is indeed a full-time employee of Lorem Co., based on the accessed personnel data. An explanation in the benefit field 440 also indicates that the user does not satisfy the second eligibility role, since the benefits engine 170 has determined that the user has neither enrolled during the open enrollment period, nor reported a qualifying life event. However, the benefits engine 170 determines that the user may become eligible for the health HMO insurance plan by reporting a qualifying life event, via the central enrollment database system 110, and the benefit field 440 indicates that the individual may become eligible for the health HMO insurance benefit if the user has a qualifying life event to report. The user may interact with the respective interactive element 450 to perform the action of reporting a qualifying life event.

In further embodiments, the benefits engine 170 performs one or more actions that now satisfy the identified eligibility rules that were not previously satisfied for a benefit in the second subset of benefits 230, in response to the user interacting with a respective interactive element 450. Responsive to the user now satisfying each of the eligibility rules corresponding to the benefit, the benefits engine 170 moves the benefit out of the second set of benefits into the first set of benefits. In response to the user interacting with the respective interactive element 450 and now satisfying each of the eligibility rules corresponding to the benefit, the interface engine 180 modifies the benefits interface by indicating that the user is now eligible for the benefit.

The interface engine 180 may modify the benefits interface by moving the benefit from UIs and UI elements associated with the second set of benefits (e.g. eligibility UI 430 and the third field 330) into UIs and UI elements associated with the first set of benefits (e.g. eligibility UI 410 and the second field 320), in response to the user interacting with the respective interactive element 450 and now satisfying each of the eligibility rules corresponding to the benefit. In some embodiments, this is performed by the interface engine 180 modifying the benefits interface by moving the benefit from the third field 330 to the second field 320. The interface engine 180 may also modify the benefits interface by removing the respective benefit from the benefit field 440 from the second eligibility UI 430 and adding a corresponding benefit field 420 for the benefit, in response to the user interacting with the respective interactive element 450 and now satisfying each of the eligibility rules corresponding to the benefit.

For example, the user may interact with the interactive element 450 corresponding to the health HMO insurance plan. In response, the benefits engine 170 reports a qualifying life event and updates the personnel database 160. Next, the benefits engine 170 moves the health HMO insurance plan to the first subset of benefits 220. The interface engine modifies the second eligibility UI 430 by removing the benefit field 440 and the interface element 450 corresponding to the health HMO insurance plan. The interface engine modifies the second eligibility UI 430 by indicating that the user is now eligible for the health HMO insurance plan.

According to some embodiments, the interface engine 180 modifies the benefits interface to display an example UI, also referred to as a third eligibility UI 460, shown in FIG. 4C, in response to the user interacting with the fifth interactive element 342. In this case, the third eligibility UI 460 displays information related to associated benefits. The benefits associated with the third eligibility UI 460 include the benefits indicated in the fourth field 340.

The third eligibility UI 460 includes one or more benefit fields 470. Each benefit field 470 indicates one of the benefits associated with the third eligibility UI 460 and displays information relevant to the indicated benefit. The displayed information in each benefit field 470 includes an explanation for why the user is ineligible for the indicated benefit, based on the eligibility rules corresponding to the indicated benefit and the personnel data for the user accessed by the benefits engine 170. The explanations in the benefit field 470 may indicate each of the eligibility rules corresponding to the indicated benefit that are not satisfied by the user. In some embodiments, the explanation also includes corresponding eligibility rules that are satisfied by the user. For each of the eligibility rules, the explanation in the benefit field 470 may also indicate the accessed personnel data that does not satisfy the eligibility rule. In other embodiments, additional information may be displayed in the benefit field 470.

For example, as shown in FIG. 4C, a benefit field 470 indicates that the user is ineligible for a health PPO 1 insurance benefit, as identified by the benefits engine 170. The health PPO 1 insurance benefit has one corresponding eligibility rule, requiring the user to be a part-time employee of Lorem Co., the example organization associated with the central enrollment database system 110. An explanation in the benefit field 470 indicates that the user does not satisfy the eligibility rule for the health PPO 1 insurance benefit because the benefits engine 170 has determined that the user is not a part-time employee of Lorem Co., but is a full-time employee, based on the accessed personnel data.

In some embodiments, the interface engine 180 modifies the benefits interface by indicating that a benefit, or subset of benefits, will move from one set of benefits to another. In this case, the benefits engine 170 updates the set of personnel data for the individual and updates each of the set of eligibility rules for the set of available benefits 210. The update may occur, in response to a user of the central enrollment database system 110 (e.g. an individual in the organization or an administrator of the central enrollment database system 110) inputting updated information to the eligibility rules database 150 and the personnel database 160. In other embodiments, the benefits in the benefits database 140 is also updated.

The benefits engine 170 identifies a subset of the first set of benefits, which will be moved to the second set of benefits in the future, based on the updated eligibility rules and the updated personnel data. For each benefit of the subset of benefits, the benefits engine 170 also identifies a subset of the corresponding set of eligibility rules that will not be satisfied in the future, based on the updated personnel data.

The interface engine 180 modifies the benefits interface by indicating the subset of benefits. Additionally, the interface engine 180 modifies the benefits interface by indicating that the subset of benefits will be moved out of the first set of benefits into the second set of benefits. The benefits interface is also modified to indicate the subset of eligibility rules corresponding to each benefit of the subset of benefits. The benefits interface may also indicate a date in the future for each of the benefits of the subset of benefits. The date corresponds to when the respective benefit will be moved out of the first set of benefits. When the corresponding date arrives, if each eligibility rule corresponding to a benefit of the subset of benefits is then not satisfied, the interface engine 180 modifies the benefits interface by moving the benefit out of the UIs and UI elements associated with the first set of benefits into the UIs and UI elements associated with the second set of benefits, according to some embodiments.

In further embodiments, the interface engine 180 also modifies the benefits interface by including an interface element for one or more of the benefits in the subset of benefits. The interface element is configured to perform one or more actions, via the central enrollment database system 110, that will satisfy the subset of eligibility rules in the future corresponding to the respective benefit. By performing the one or more actions, the respective benefit will remain in the first set of eligibility rules in the future. Therefore, an individual may be notified of an upcoming change to the eligibility of a benefit in the first set of benefits and may take actions to prevent the benefit from being moved to the second set of benefits.

In an alternate embodiment, the benefits engine 170 identifies a subset of the second set of benefits, which will be moved to the first set of benefits in the future, based on the updated eligibility rules and the updated personnel data. For each benefit of the subset of benefits, the benefits engine 170 also identifies a subset of the updated set of eligibility rules that will become satisfied in the future, based on the updated set of personnel data.

The interface engine 180 modifies the benefits interface by indicating the subset of benefits and by indicating the subset of eligibility rules for each benefit. Additionally, the interface engine 180 modifies the benefits interface by indicating that the subset of benefits will be moved out of the second set of benefits into the first set of benefits. The benefits interface may also indicate a date in the future for each of the benefits of the subset of benefits. The date corresponds to when the respective benefit will be moved out of the second set of benefits. When the corresponding date arrives, if each eligibility rule corresponding to a benefit of the subset of benefits is then satisfied, the interface engine 180 modifies the benefits interface by moving the benefit out of the UIs and UI elements associated with the second set of benefits into the UIs and UI elements associated with the first set of benefits, according to some embodiments.

In some embodiments, the update to the set of personnel data may include a change in the number of dependents for the individual, a qualifying life event for the individual, a change in title or role of the individual within the organization, a change in income received from the organization, a change in residence, a change in place of business, and a change in an enrollment in benefits for the individual.

Thus, a user of the central enrollment database system 110 may be notified or informed of an upcoming change in eligibility for one or more of the available benefits.

### Processes for Determining and Displaying Subsets of Benefits

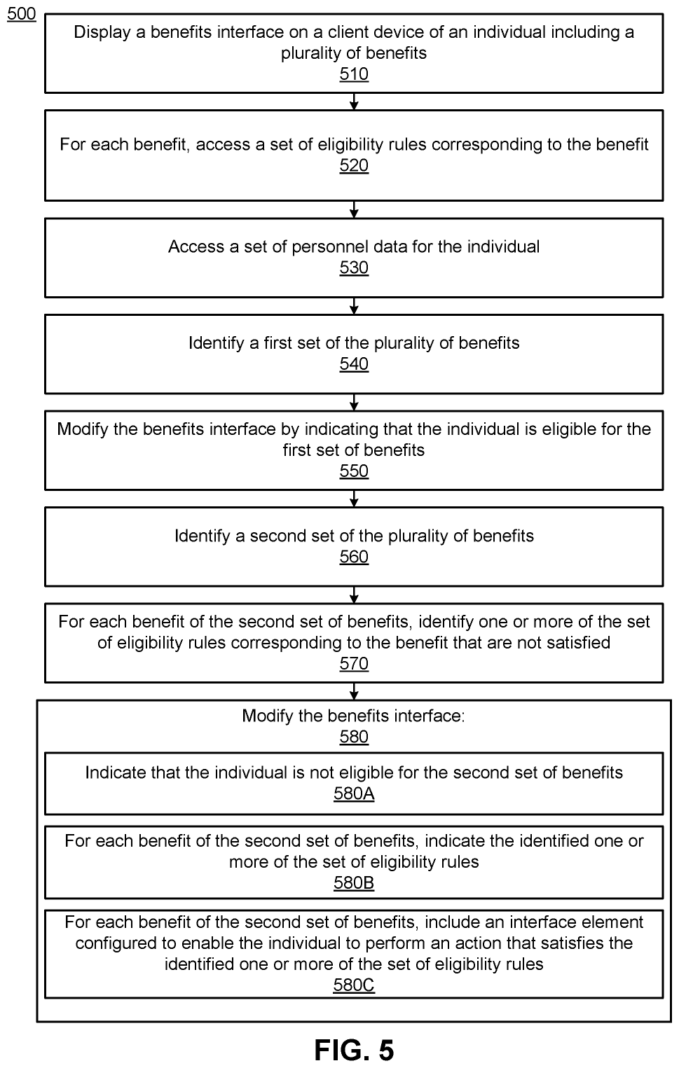

FIG. 5 is a flowchart illustrating a process for determining subsets of benefits in a central enrollment database system and modifying a benefits interface to indicate the subsets of benefits to an individual, in accordance with an embodiment. The process 500 may be performed by the central enrollment database system 110.

The process 500 for determining subsets of benefits in the central enrollment database system 110 and for modifying a benefits interface to indicate the subset of benefits to an individual includes displaying 510 displaying on a client device 130 of the individual, by the interface engine 180, a benefits interface including a plurality of benefits corresponding to an organization to which the individual belongs to. For each of the plurality of benefits, the benefits engine 170 accesses 520 a set of eligibility rules corresponding to the benefit from the eligibility rules database 150, wherein each eligibility rule in the set of eligibility rules must be satisfied by the individual in order for the individual to be eligible for the benefit. The interface engine 170 accesses 530 a set of personnel data for the individual corresponding to the organization from the personnel database 160. Then, the benefits engine identifies 540 a first set of the plurality of benefits, wherein the set of eligibility rules corresponding to each of the first set of benefits is satisfied by the accessed set of personnel data. The interface engine 180 modifies 550 the benefits interface displayed by the client device 130, by indicating that the individual is eligible for the first set of benefits.

Next, the benefits engine 170 identifies 560 a second set of the plurality of benefits, wherein the set of eligibility rules corresponding to each of the second set of benefits is not satisfied by the accessed set of personnel data. For each benefit of the second set of benefits, the benefits engine 170 also identifies 570 one or more of the set of eligibility rules corresponding to the benefit that are not satisfied.

The interface engine 180 then modifies 580 the benefits interface displayed by the client device 130. The modifying 580 of the benefits interface includes indicating 580A that the individual is not eligible for the second set of benefits. For each benefit of the second set of benefits, the benefits interface is also modified 580 to indicate 580B each of the identified one or more of the set of eligibility rules corresponding to the benefit that are not satisfied. Additionally, the modifying 580 of the benefits interface involves including 580C, for each benefit of the second set of benefits, an interface element configured to, when the individual interacts with the interface element, enable the individual to perform an action that satisfies the identified one or more of the set of eligibility rules corresponding to the benefit that are not satisfied.

### Advantages

The central enrollment database system 110 provides a platform for efficiently determining subsets of benefits for individuals in an organization and displaying the subsets of benefits to the individuals on a client device. The benefits interface provided by the interface engine 180 allows an individual to easily manage their enrollment in benefits and understand the factors for eligibility for each of the benefits. This provides the advantage of improved transparency between the individual and the organization. Additionally, by identifying and indicating actions for satisfying eligibility requirements in the benefits interface, the central enrollment database system 110 enables the individual to perform actions through the central enrollment database system 110 from the same benefits interface and that they may not be aware of, otherwise.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
displaying, by a central enrollment database system on a client device of an individual, a benefits interface, the benefits interface including a plurality of benefits corresponding to an organization to which the individual belongs;
for each of the plurality of benefits, accessing, by the central enrollment database system, a set of eligibility rules corresponding to the benefit, wherein each eligibility rule in the set of eligibility rules must be satisfied by the individual in order for the individual to be eligible for the benefit;
accessing, by the central enrollment database system, a set of personnel data for the individual from a database corresponding to the organization;
identifying, by the central enrollment database system, a first set of the plurality of benefits, wherein the set of eligibility rules corresponding to each of the first set of benefits is satisfied by the accessed set of personnel data;
modifying, by the central enrollment database system, the benefits interface displayed by the client device by indicating that the individual is eligible for the first set of benefits;
identifying, by the central enrollment database system, a second set of the plurality of benefits, wherein the set of eligibility rules corresponding to each of the second set of benefits is not satisfied by the accessed set of personnel data;
identifying, by the central enrollment database system for each benefit of the second set of benefits, one or more of the set of eligibility rules corresponding to the benefit that are not satisfied; and
modifying, by the central enrollment database system, the benefits interface displayed by the client device by:
indicating that the individual is not eligible for the second set of benefits;
indicating, for each benefit of the second set of benefits, the identified one or more of the set of eligibility rules corresponding to the benefit that are not satisfied; and
including, for each benefit of the second set of benefits, an interface element configured to, when the individual interacts with the interface element, enable the individual to perform one or more actions that satisfies the identified one or more of the set of eligibility rules corresponding to the benefit that are not satisfied.

2. The method of claim 1, further comprising modifying, by the central enrollment database system, the benefits interface displayed by the client device by indicating a recommendation corresponding to the one or more actions for a benefit of the second set of benefits.

3. The method of claim 1, wherein the set of eligibility rules comprises a rule based on at least one of:
an employment status of the individual, an age of the individual, a health status of the individual, a behavioral status of the individual, a tenure of the individual at the organization, a residence of the individual, a life event of the individual, a parental status of the individual, a number of dependents of the individual, an enrollment status of dependents of the individual, and an enrollment of the individual in a benefit.

4. The method of claim 1, wherein the set of eligibility rules comprises a rule based on at least one of:
an allowance for a number of enrolled individuals for the organization, a location of the organization, a legal requirement of the organization, and a policy set by the organization.

5. The method of claim 1, further comprising:
updating, by the central enrollment database system, the set of personnel data;
updating, by the central enrollment database system, each of the set of eligibility rules;
identifying, by the central enrollment database system, a subset of the first set of benefits;
identifying, by the central enrollment database system, for each benefit of the subset of benefits, a subset of the updated set of eligibility rules that will not be satisfied in the future, based on the updated set of personnel data;
modifying, by the central enrollment database system, the benefits interface displayed by the client device by:
indicating the subset of benefits;
indicating that the subset of benefits will be moved out of the first set of benefits, by the central enrollment database system, into the second set of benefits, and
indicating the subset of eligibility rules corresponding to each benefit of the subset of benefits.

6. The method of claim 5, further comprising modifying, by the central enrollment database system, the benefits interface by including an interface element for each of the benefits in the subset of benefits, the interface element configured to perform one or more actions that will satisfy the subset of eligibility rules in the future, such that the respective benefit will remain in the first set of eligibility rules in the future.

7. The method of claim 5, further comprising modifying, by the central enrollment database system, the benefits interface by indicating a date in the future for each of the benefits in the subset of benefits when the respective benefit will be moved out of the first set of benefits.

8. The method of claim 5, wherein the updated set of personnel data includes at least one selected from the group consisting of a change in the number of dependents for the individual, a qualifying life event for the individual, a change in title or role of the individual within the organization, a change in income received from the organization, a change in residence, a change in place of business, and a change in an enrollment in benefits for the individual.

9. The method of claim 1, further comprising:
updating, by the central enrollment database system, the set of personnel data;
updating, by the central enrollment database system, each of the set of eligibility rules;
identifying, by the central enrollment database system, a subset of the second set of benefits;
identifying, by the central enrollment database system, for each benefit of the subset of benefits, a subset of the updated set of eligibility rules that will be satisfied in the future, based on the updated set of personnel data;
modifying, by the central enrollment database system, the benefits interface displayed by the client device by:
indicating the subset of the benefits;
indicating that the subset of benefits will be moved out of the second set of benefits, by the central enrollment database system, into the first set of benefits, and
indicating the subset of eligibility rules corresponding to each benefit of the subset of benefits.

10. The method of claim 9, further comprising modifying, by the central enrollment database system, the benefits interface by indicating a date in the future for each benefit in the subset of benefits corresponding to when the respective benefit will be moved out of the second set of benefits.

11. The method of claim 9, wherein the updated set of personnel data includes at least one selected from the group consisting of a change in the number of dependents for the individual, a qualifying life event for the individual, a change in title or role of the individual within the organization, a change in income received from the organization, a change in residence, a change in place of business, and a change in an enrollment in benefits for the individual.

12. The method of claim 1, further comprising, for each benefit of the second set of benefits:
responsive to the individual interacting with the interface element, performing, by the central enrollment database system, the one or more actions that satisfy the identified one or more of the set of eligibility rules corresponding to the benefit that was not satisfied;
responsive to the individual now satisfying each of eligibility rules of the set of eligibility rules corresponding to the benefit, moving the benefit out of the second set of benefits into the first set of benefits; and
responsive to the individual interacting with the interface element and now satisfying the set of eligibility rules corresponding to the benefit, modifying, by the central enrollment database system, the benefits interface by indicating that the user is now eligible for the benefit.

13. The method of claim 1, wherein the personnel data comprises biographic and demographic information for the individual.

14. The method of claim 1, further comprising:
receiving, by the central enrollment database system, a set of preferences associated with the individual; and
enrolling, by the central enrollment database system, the individual in a subset of the first set of benefits based on the set of preferences.

15. The method of claim 1, wherein the personnel data comprises data corresponding to one or more dependents of the individual, and the plurality of benefits further comprise benefits corresponding to the one or more dependents.

16. The method of claim 1, further comprising modifying, by the central enrollment database system, the benefits interface by indicating each of the eligibility rules corresponding to the first set of benefits that are satisfied by the accessed personnel data.

17. The method of claim 1, wherein the one or more actions include updating or changing the set of personnel data for the individual in the database corresponding to the organization to reflect one selected from the group comprising a change in employment information, a change in residence for the individual, a change in location of employment for the individual, a change in the number of reported dependents for the individual, and a reporting of a life event.

18. The method of claim 1, wherein the one or more actions include one selected from the group comprising changing the individual's benefits elections, and changing the individual's earnings withholdings.

19. A central enrollment database system configured to perform steps comprising:
displaying, by a central enrollment database system on a client device of an individual, a benefits interface, the benefits interface including a plurality of benefits corresponding to an organization to which the individual belongs;
for each of the plurality of benefits, accessing, by the central enrollment database system, a set of eligibility rules corresponding to the benefit, wherein each eligibility rule in the set of eligibility rules must be satisfied by the individual in order for the individual to be eligible for the benefit;
accessing, by the central enrollment database system, a set of personnel data for the individual from a database corresponding to the organization;
identifying, by the central enrollment database system, a first set of the plurality of benefits, wherein the set of eligibility rules corresponding to each of the first set of benefits is satisfied by the accessed set of personnel data;
modifying, by the central enrollment database system, the benefits interface displayed by the client device by indicating that the individual is eligible for the first set of benefits;
identifying, by the central enrollment database system, a second set of the plurality of benefits, wherein the set of eligibility rules corresponding to each of the second set of benefits is not satisfied by the accessed set of personnel data;
identifying, by the central enrollment database system for each benefit of the second set of benefits, one or more of the set of eligibility rules corresponding to the benefit that are not satisfied; and
modifying, by the central enrollment database system, the benefits interface displayed by the client device by:
indicating that the individual is not eligible for the second set of benefits;
indicating, for each benefit of the second set of benefits, the identified one or more of the set of eligibility rules corresponding to the benefit that are not satisfied; and
including, for each benefit of the second set of benefits, an interface element configured to, when the individual interacts with the interface element, enable the individual to perform one or more actions that satisfies the identified one or more of the set of eligibility rules corresponding to the benefit that are not satisfied.

20. A non-transitory computer readable storage medium storing executable instructions that, when executed by one or more processors, cause the one or more processors to perform steps comprising:
displaying, by a central enrollment database system on a client device of an individual, a benefits interface, the benefits interface including a plurality of benefits corresponding to an organization to which the individual belongs;
for each of the plurality of benefits, accessing, by the central enrollment database system, a set of eligibility rules corresponding to the benefit, wherein each eligibility rule in the set of eligibility rules must be satisfied by the individual in order for the individual to be eligible for the benefit;
accessing, by the central enrollment database system, a set of personnel data for the individual from a database corresponding to the organization;
identifying, by the central enrollment database system, a first set of the plurality of benefits, wherein the set of eligibility rules corresponding to each of the first set of benefits is satisfied by the accessed set of personnel data;
modifying, by the central enrollment database system, the benefits interface displayed by the client device by indicating that the individual is eligible for the first set of benefits;
identifying, by the central enrollment database system, a second set of the plurality of benefits, wherein the set of eligibility rules corresponding to each of the second set of benefits is not satisfied by the accessed set of personnel data;
identifying, by the central enrollment database system for each benefit of the second set of benefits, one or more of the set of eligibility rules corresponding to the benefit that are not satisfied; and
modifying, by the central enrollment database system, the benefits interface displayed by the client device by:
indicating that the individual is not eligible for the second set of benefits;
indicating, for each benefit of the second set of benefits, the identified one or more of the set of eligibility rules corresponding to the benefit that are not satisfied; and
including, for each benefit of the second set of benefits, an interface element configured to, when the individual interacts with the interface element, enable the individual to perform one or more actions that satisfies the identified one or more of the set of eligibility rules corresponding to the benefit that are not satisfied.
